(19) United States
(12) Patent Application Publication
(10) Pub. No.: US 2026/0285285 A1
(43) Pub. Date: Sep. 24, 2026

(54) CONTROL DEVICE FOR VEHICLE

(71) Applicant: HONDA MOTOR CO., LTD., Tokyo (JP)

(72) Inventors: Noriaki SUZUKI, Tokyo (JP); Kazuya SAKURAI, Tokyo (JP); Masaki MORIKAWA, Tokyo (JP)

(21) Appl. No.: 19/448,116

(22) Filed: Jan. 14, 2026

(30) Foreign Application Priority Data
Mar. 19, 2025 (CN) 202510327512.7

(51) Int. Cl. B60W 10/06; B60W 10/02; B60W 10/08; B60W 20/40; B60W 30/14; B60W 30/18

(52) U.S. Cl. CPC B60W 10/06; B60W 10/02; B60W 10/08; B60W 20/40; B60W 30/143; B60W 30/18027

(57) ABSTRACT

Provided is a control device for a vehicle that is capable of suppressing occurrence of a deceleration failure contrary to an intention of a driver. A control device 1 for a vehicle that includes a motor 15 as a drive source for traveling is capable of changing deceleration force of the vehicle in accordance with a magnitude of a regeneration level of the motor 15 and has a plurality of travel modes in which the regeneration level is changeable by an operation of a driver. The travel modes includes a first travel mode and a second travel mode. When a change takes place from the first travel mode to the second travel mode, the control device sets an initial regeneration level of the second travel mode based on the regeneration level selected in the first travel mode.

### CROSS REFERENCE TO THE RELATED APPLICATION

This application is based on and claims the benefit of priority from Chinese Patent Application CN202510327512.7, filed on 19 March 2025, the content of which is incorporated herein by reference.

### BACKGROUND OF THE INVENTION

### Field of the Invention

The present invention relates to a control device for a vehicle.

### Related Art

A hybrid electric vehicle equipped with an engine and a motor for traveling as drive sources for the vehicle is known. In such a hybrid electric vehicle, during traveling by drive force of the motor for traveling, a battery can be charged with regenerative electric power generated during deceleration, and regenerative braking force such as engine braking can be applied to the wheels. With regard to such regenerative braking force, Japanese Unexamined Patent Application, Publication No. 2016-43908 discloses a vehicle having a first shift pattern in which a regeneration level is changeable by a paddle, and a second shift pattern in which the regeneration level is changeable by an operation of a shift lever. The first shift pattern and the second shift pattern are switchable by a selection of a driver.

Patent Document 1: Japanese Unexamined Patent Application, Publication No. 2016-43908

### SUMMARY OF THE INVENTION

In the technology disclosed in Patent Document 1, regenerative brake force serving as a reference when switching takes places between the shift patterns is determined from among a plurality of regeneration levels in advance. Specifically, regenerative brake force right after switching between the shift patterns is set to a predetermined initial setting level irrespective of regenerative brake force before the switching.

Thus, the conventional control device for a vehicle has a disadvantage that, when the switching between the shift patterns takes place in a state in which a regeneration level having strong regenerative brake force is selected, regenerative brake force returns to the initial setting level, and accordingly, an unintended deceleration failure occurs even in a scene in which the driver intends to decelerate, and the driver feels a sense of discomfort in some cases.

Thus, the present invention is made in view of the above-described disadvantage and is intended to provide a control device for a vehicle that is capable of suppressing occurrence of a deceleration failure contrary to an intention of a driver, thereby improving safety of the vehicle. The present invention further contributes to development of a sustainable transportation system by further improving traffic safety.

(1) An embodiment of the present invention is directed to a control device for a vehicle that includes an electric motor as a drive source for traveling. The control device is capable of changing deceleration force of the vehicle in accordance with a magnitude of regeneration level of the electric motor and has a plurality of travel modes in which the regeneration level is changeable by an operation of a driver. The plurality of travel modes includes a first travel mode and a second travel mode. When a change takes place from the first travel mode to the second travel mode, the control device sets an initial regeneration level of the second travel mode based on the regeneration level selected in the first travel mode.

The control device described above is capable of suppressing occurrence of a deceleration failure contrary to an intention of a driver.

When a change takes place from the first travel mode, for example, a two-pedal mode, to the second travel mode, for example, a single-pedal mode, a regeneration level that is first set when a change took place to the second travel mode is set in consideration of a regeneration level that was selected before the change in the first travel mode. Accordingly, deceleration force at a mode change can be set to deceleration force that is suitable for a travel scene. Note that the regeneration level that is first set at the mode change is defined as an initial regeneration level. In addition, deceleration force in the initial regeneration level is defined as initial deceleration force.

Moreover, according to the control device for a vehicle as described above, the initial deceleration force can be set to deceleration force that is suitable for a preference of the driver.

(2) When a change takes place from the first travel mode to the second travel mode, the control device may set an initial regeneration level at a time of the change to the second travel mode to a regeneration level that is substantially the same in the deceleration force as the regeneration level selected in the first travel mode, or to a regeneration level that is greater in the deceleration force than the regeneration level selected in the first travel mode.

According to such a control device for a vehicle, it is possible to prevent occurrence of a deceleration failure at a change between the travel modes when the driver has an intention to decelerate.

Moreover, since a side with stronger deceleration force is held at a change between the travel modes, it is possible to perform a change between the travel modes with safety further taken into consideration.

(3) The control device for a vehicle may include a storage configured to store the regeneration level selected before a change between the travel modes, and when a change takes place between the travel modes, the control device may compare the regeneration level in the first travel mode that is currently selected with a previous regeneration level in the second travel mode that is stored in the storage, and may set the initial regeneration level to the regeneration level or the previous regeneration level which is greater in the deceleration force.

According to such a control device for a vehicle, it is possible to set an operational feeling in the single-pedal mode after a mode change to an operational feeling similar to that at a time of the previous single-pedal mode, and to suppress a deceleration failure at a change between the travel modes.

(4) In the control device for a vehicle, a range of the regeneration level that is changeable may include a first regeneration level having a predetermined selection range in the first travel mode, and a second regeneration level having a smaller selection range than the first regeneration level in the second travel mode.

According to such a control device for a vehicle, when a change takes place to a travel mode having a different number of steps, the previous regeneration level is considered irrespective of a difference in the number of steps before and after the change, and thus the initial deceleration force can be set to deceleration force that is suitable for a travel scene.

By providing a travel mode having a range with a small number of regeneration levels, regenerative braking force can be easily controlled to increase and decrease with fewer operations, and an operational burden on the driver can be reduced.

In a travel mode having a range with a large number of regeneration levels, the regeneration level can be finely set.

(5) In the control device for a vehicle, the first travel mode may be a two-operation-member travel mode in which acceleration and deceleration of the vehicle are performed by two operation members, and the second travel mode may be a one-operation-member travel mode in which acceleration and deceleration of the vehicle are performed by one operation member.

According to such a control device for a vehicle, the two-operation-member travel mode and the one-operation-member travel mode can be switched.

In an operation by a single pedal in the second travel mode in which the frequency of pedal switching is low, the range of regeneration levels that can be selected is smaller in the second travel mode (single-pedal travel mode) in addition to an effect of reducing an operational burden of the pedal, and thus an operational burden on the driver can be further reduced.

(6) In the control device for a vehicle, the regeneration level may be changeable by an operation member provided on a steering wheel.

According to such a control device for a vehicle, for example, at a travel mode change to the single-pedal travel mode, the same operational feeling can be set for an operation member for setting deceleration force by regeneration force although an operational feeling by a pedal operation member under a foot changes.

Moreover, since the regeneration level, that is, deceleration level can be changed without releasing a hand from the steering wheel, an operational burden on the driver can be reduced.

(7) In the control device for a vehicle, the regeneration level may be changeable by the same operation member in the first travel mode and the second travel mode.

According to such a control device for a vehicle, the deceleration level can be changed without releasing a hand from the steering wheel, and operations can be performed by the same operation member in each travel mode. Thus, deceleration force can be obtained without a sense of discomfort despite a change between the travel modes.

Moreover, since the deceleration level can be changed without releasing a hand from the steering wheel, an operational burden on the driver can be reduced.

According to the present invention, it is possible to provide a control device for a vehicle that is capable of suppressing occurrence of a deceleration failure contrary to an intention of a driver, thereby improving safety of the vehicle.

### BRIEF DESCRIPTION OF THE DRAWINGS

FIG. 1 is a diagram illustrating a schematic configuration of a control device for a vehicle according to an embodiment of the present invention;

FIG. 2 is a schematic view illustrating transitions of a plurality of deceleration steps.

### DETAILED DESCRIPTION OF THE INVENTION

A control device for a vehicle according to an embodiment of the present invention will be described below with reference to the accompanying drawings. The control device for a vehicle according to the present embodiment has two travel modes. One of the two travel modes is defined as a first travel mode, and the other is defined as a second travel mode.

The first travel mode is a travel mode in which acceleration and deceleration of the vehicle are performed by two operation members. The first travel mode is also referred to as a two-pedal mode. The two operation members used in the first travel mode are referred to as an accelerator operation member and a brake operation member. The accelerator operation member is also referred to as an acceleration pedal. The brake operation member is also referred to as a brake pedal.

The second travel mode is a travel mode in which acceleration and deceleration of the vehicle are performed by one operation member. The second travel mode is also referred to as a single-pedal (one-pedal) mode. The one operation member used in the second travel mode is referred to as a single acceleration-deceleration operation member. The acceleration-deceleration operation member is also referred to as an acceleration-deceleration pedal.

The acceleration-deceleration pedal in the second travel mode may be the acceleration pedal in the first travel mode. In other words, the acceleration-deceleration operation member and the accelerator operation member may be one operation member.

As for shift modes, the control device for a vehicle has a fixed shift mode and a smart shift mode. The fixed shift mode is a shift mode in which a plurality of deceleration steps are switchable based on an operation of the driver. An automatic shift mode is a shift mode in which a plurality of deceleration steps are switchable based on the traveling state of the vehicle. The automatic shift mode is also referred to as the smart shift mode.

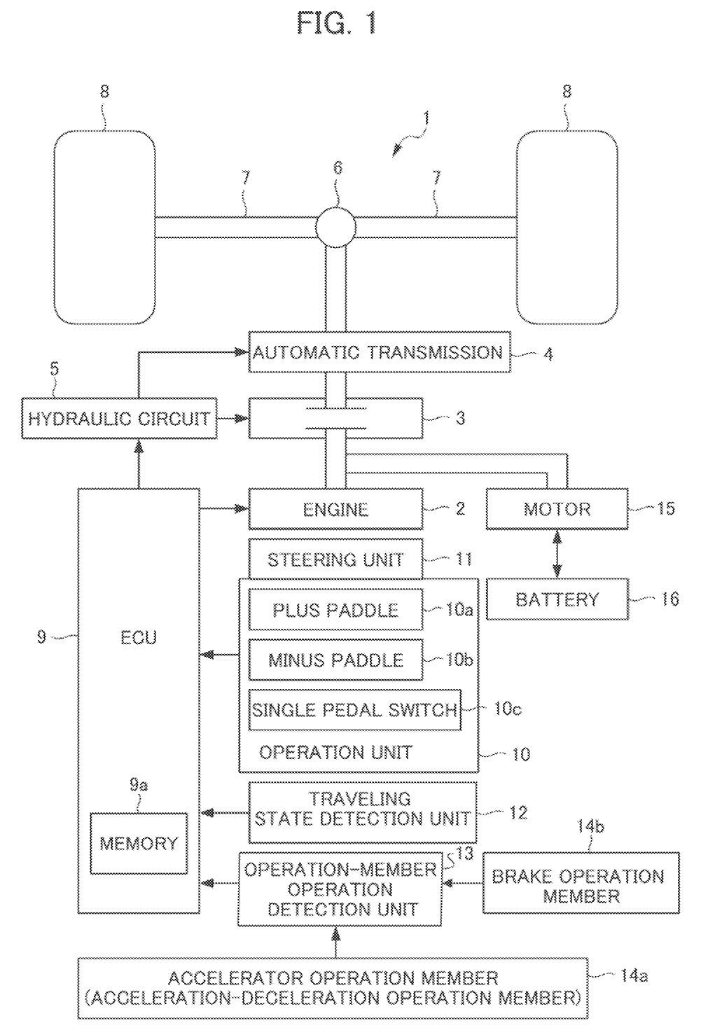

The configuration of a control device 1 for a vehicle according to the embodiment of the present invention will be described below with reference to FIG. 1. FIG. 1 is a diagram illustrating a schematic configuration of the control device 1 for a vehicle according to the embodiment of the present invention.

As illustrated in FIG. 1, the control device 1 for a vehicle includes an engine 2 as a power source, a clutch 3, an automatic transmission 4 that functions as a deceleration unit, a hydraulic circuit 5, a differential mechanism 6, a pair of left and right drive shafts 7, a pair of left and right drive wheels 8, an electric control unit (ECU) 9, an operation unit 10 that includes a plus paddle 10a and a minus paddle 10b and functions as a shift device or a paddle shift, a steering unit 11, a traveling state detection unit 12, an operation-member operation detection unit 13, an accelerator operation member 14a, a brake operation member 14b, a motor 15, and a battery 16.

The engine 2 is a power source that generates power of the vehicle, that is, a drive source. In the present embodiment, a hybrid engine in which an electric motor, specifically, the motor 15 is combined in addition to the engine 2 is employed as the drive sources. Power generated by the hybrid engine is transmitted to the pair of left and right drive shafts 7, to which the pair of left and right drive wheels 8 are attached, through the clutch 3, the automatic transmission 4, and the differential mechanism 6.

The clutch 3 disconnects, in accordance with the pressure of working oil supplied from the hydraulic circuit 5, that is, hydraulic pressure, a transmission path of power generated by the hybrid engine and transmitted to the pair of left and right drive shafts 7.

The automatic transmission 4 adjusts a gear ratio in accordance with the pressure of the working oil supplied from the hydraulic circuit 5.

The hydraulic circuit 5 supplies the pressure of the working oil to the clutch 3 and the automatic transmission 4 based on control by the ECU 9.

The differential mechanism 6 distributes power generated by the hybrid engine and transmitted through the clutch 3 and the automatic transmission 4 to the pair of left and right drive shafts 7. The pair of left and right drive wheels 8 are attached to the pair of left and right drive shafts 7, respectively. The pair of left and right drive wheels 8 converts power transmitted through the pair of left and right drive shafts 7 into propulsive force of the vehicle.

The ECU 9 controls the engine 2, the motor 15, the battery 16, the hydraulic circuit 5, and the like based on inputs from the operation unit 10, the traveling state detection unit 12, the operation-member operation detection unit 13, and the like. The ECU 9 performs various kinds of processing by reading and executing computer programs stored in a memory 9a included in the ECU 9.

The ECU 9 and the motor 15 constitute a deceleration unit according to the present embodiment. The deceleration unit according to the present embodiment has a plurality of deceleration steps to which the deceleration of the vehicle is changeable.

The motor 15 generates drive force when the driver accelerates by depressing the accelerator operation member 14a that is, the acceleration pedal, whereas the motor 15 becomes an electric generator by opposite force acting when the driver decelerates by releasing a foot from the accelerator operation member 14a. Force required for the power generation becomes a resistance to rotation of the drive wheels 8 and functions as a regenerative brake, and the deceleration unit according to the present embodiment is capable of changing the strength of the regenerative brake in stages by controlling rotation of the motor 15 by the ECU 9. Specifically, the deceleration unit according to the present embodiment is capable of changing the deceleration of the vehicle in stages in accordance with operations of the driver on the plus paddle 10a and the minus paddle 10b, which are referred to as a deceleration selector to be described later.

The brake operation member 14b is operated to adjust braking force in the above-described two-pedal mode.

The operation unit 10 is provided in the steering unit 11. The operation unit 10 may be configured to be capable of selecting and switching the travel modes in accordance with operations of the driver. Moreover, it may be configured that the travel modes can be selected and switched by another device other than the operation unit 10.

The operation unit 10 is a shift device capable of changing a plurality of deceleration steps. The operation unit 10 as a shift device includes the plus paddle 10a as a first operation unit, and the minus paddle 10b as a second operation unit. The plus paddle 10a is capable of switching to a deceleration step having a deceleration smaller than the deceleration of a currently selected deceleration step. The minus paddle 10b is capable of switching to a deceleration step having a deceleration larger than the deceleration of the currently selected deceleration step.

The operation unit 10 further includes a single pedal switch 10c. The single pedal switch 10c is a switch for the driver to switch the travel mode from the first travel mode to the second travel mode. The single pedal switch 10c is provided on, for example, a steering wheel as the steering unit 11. Note that a position where the single pedal switch 10c is provided is not limited to the steering wheel or the like. Furthermore, the aspect of the single pedal switch 10c is not particularly limited as long as travel mode switching is possible.

The traveling state detection unit 12 detects the traveling state of the vehicle. The traveling state detection unit 12 inputs a detection signal to the ECU 9 as for the detected traveling state of the vehicle.

The operation-member operation detection unit 13 detects the operation state of the accelerator operation member 14a and the brake operation member 14b. As described later, when the accelerator operation member 14a functions as the acceleration-deceleration operation member, the operation state of the acceleration-deceleration operation member is detected. The operation-member operation detection unit 13 inputs the detected operation state of the operation member to the ECU 9.

The motor 15 generates electric power by being rotated by power of the engine 2. The motor 15 also serves as a power source that generates power of the vehicle by using electric power of the battery 16.

The battery 16 charges electric power generated by the motor 15.

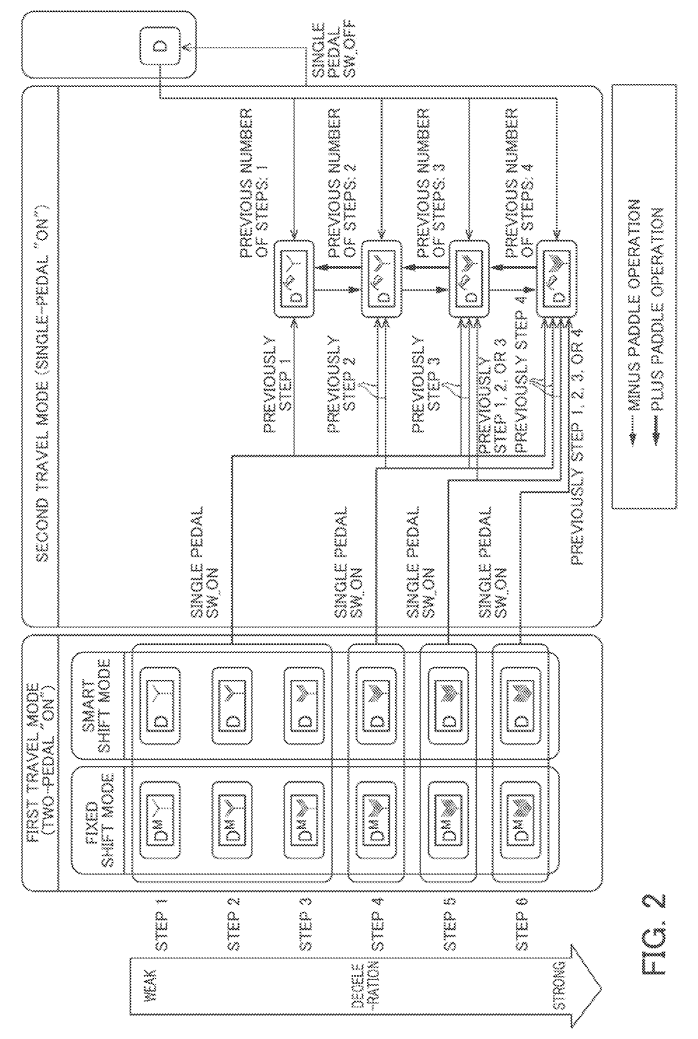

The travel modes, a plurality of deceleration steps of the deceleration unit, and transitions thereof in the present embodiment will be described below with reference to FIG. 2. FIG. 2 is a schematic diagram of a regeneration level and the like for description of the travel modes and transitions of a plurality of deceleration steps.

As described above, the vehicle includes an electric motor as a drive source for traveling. Deceleration force of the vehicle is changeable in accordance with the magnitude of the regeneration level of the electric motor. The vehicle according to the present embodiment has a plurality of travel modes in which the regeneration level is changeable by an operation of the driver.

### Travel Modes

FIG. 2 illustrates the first travel mode and the second travel mode.

The first travel mode is also referred to as a two-pedal mode as described above, and is a travel mode in which acceleration and deceleration of the vehicle are performed by operations of the accelerator operation member 14a and the brake operation member 14b. In the first travel mode, an integrated dynamics system (IDS) is set to other than CITY (urban area), and the deceleration selector is "ON".

The second travel mode is also referred to as a single-pedal mode, and is a travel mode in which acceleration and deceleration of the vehicle are performed by an operation of the single acceleration-deceleration operation member. In the second travel mode, the IDS is set to CITY.

A mode change between the travel modes will be described below. In a D range that is travel mode used during normal traveling, the travel mode becomes the first travel mode through a paddle operation. When the single pedal switch 10c is operated to "ON" in the state of the first travel mode, the travel mode is switched to the second travel mode. When the single pedal switch 10c is operated to "OFF" in the state of the second travel mode, the travel mode is returned to the D range.

### Regeneration Level and Deceleration Steps

The regeneration level will be described below. The regeneration level has a plurality of steps among which deceleration force and deceleration G are different. Each step is referred to as a deceleration step.

As illustrated in FIG. 2, the plurality of deceleration steps include a first deceleration step, a second deceleration step having a deceleration larger than the deceleration of the first deceleration step, a third deceleration step having a deceleration larger than the deceleration of the second deceleration step, a fourth deceleration step having a deceleration larger than the deceleration of the third deceleration step, a fifth deceleration step having a deceleration larger than the deceleration of the fourth deceleration step, and a sixth deceleration step having a deceleration larger than the deceleration of the fifth deceleration step. Note that, in the following description, the first deceleration step is also simply referred to as Step 1. This is the same for the other deceleration steps.

The first travel mode has, as shift modes, the fixed shift mode and the smart shift mode. As illustrated in FIG. 2, the fixed shift mode and the smart shift mode each have deceleration steps of Step 1 to Step 6.

Unlike the first travel mode, the second travel mode has four deceleration steps instead of six deceleration steps. Specifically, the second travel mode has deceleration steps of Step 1 to Step 4 instead of Step 1 to Step 6. Step 1 in the second travel mode has a strength of deceleration corresponding to Step 3 in the first travel mode. Similarly, Step 2 in the second travel mode has a strength of deceleration corresponding to Step 4 in the first travel mode, Step 3 in the second travel mode has a strength of deceleration corresponding to Step 5 in the first travel mode, and Step 4 in the second travel mode has a strength of deceleration corresponding to Step 6 in the first travel mode. Accordingly, the second travel mode has steps corresponding to four kinds of steps having strong deceleration in the first travel mode.

### Change Between Travel Modes

The regeneration level when a change takes place between the travel modes will be described below. The regeneration level that is first set when a change takes place between the travel modes is defined as an initial regeneration level. Deceleration force in the initial regeneration level is defined as initial deceleration force.

### Setting of Initial Regeneration Level

The regeneration level when a change takes place from the first travel mode to the second travel mode will be described below as an example with reference to FIG. 2. The initial regeneration level sets the number of steps in a travel mode after the change, that is, the second travel mode (single-pedal "ON"), in consideration of the number of steps in the previous travel mode, that is, the first travel mode (two-pedal "ON").

Specifically, the initial regeneration level of the second travel mode is set based on the regeneration level that has been selected in the first travel mode, when a change takes place from the first travel mode to the second travel mode. This means that the initial regeneration level is not determined in advance, for example, as "a step having a weakest deceleration among deceleration steps set in a travel mode after a change", but the initial regeneration level is set in accordance with a deceleration step before the change.

According to such a control device 1 for a vehicle, when a change takes place from the first travel mode, for example, the two-pedal mode to the second travel mode, for example, the single-pedal mode, a regeneration level that is first set at a time of the change to the second travel mode is set in consideration of a regeneration level selected before the change in the first travel mode. Accordingly, deceleration force at a mode change can be set to deceleration force that is suitable for a travel scene. Moreover, according to the control device for a vehicle as described above, the initial deceleration force can be set to deceleration force that is suitable for a preference of the driver. Thus, it is possible to provide a control device for a vehicle that is capable of suppressing occurrence of a deceleration failure contrary to an intention of a driver, thereby improving safety of the vehicle.

A specific scheme of setting the initial regeneration level will be described below. Specifically, an example of how setting of the initial regeneration level is based on a regeneration level selected in the first travel mode will be described.

### Step Maintenance or Stronger Step

The initial regeneration level can be set so as to maintain the number of steps in the previous travel mode or to change to the number of steps having a stronger regeneration level. Specifically, the initial regeneration level at a time of a change to the second travel mode is set to a regeneration level that is substantially the same in the deceleration force as a regeneration level selected in the first travel mode, or to a regeneration level that is larger in the deceleration force than the regeneration level that has been selected in the first travel mode.

According to such a control device for a vehicle, it is possible to prevent occurrence of a deceleration failure at a change between the travel modes when the driver has an intention to decelerate.

This can be said to mean, when the single-pedal mode is activated during activation of the deceleration selector, the higher one is selected between the current number of steps of the deceleration selector and the number of steps to which the single-pedal mode is shifted. Accordingly, it is possible to prevent a decrease in the deceleration when switching takes place from the two-pedal mode to the single-pedal mode.

A specific example of setting of the initial regeneration level in a case where the initial regeneration level is set as described above will be described below. For example, in a case where Step 1, Step 2, or Step 3 is selected in the first travel mode, Step 1 or higher is set as the initial regeneration level of the second travel mode. In a case where Step 4 is selected in the first travel mode, Step 2 or higher is set as the initial regeneration level of the second travel mode. In a case where Step 5 is selected in the first travel mode, Step 3 or higher is set as the initial regeneration level of the second travel mode. In a case where Step 6 is selected in the first travel mode, Step 4 or higher is set as the initial regeneration level of the second travel mode.

In this manner, in a case where the single-pedal mode is activated during activation of the deceleration selector, the initial regeneration level can be set so that the deceleration is maintained or increased.

### Comparison with Previous Number of Steps

The initial regeneration level may be set by comparing the number of steps in the previous first travel mode (two-pedal mode) and the number of steps in the previous second travel mode (single-pedal mode).

In this case, the control device 1 for a vehicle includes a storage configured to store a regeneration level that has been selected before a change between the travel modes. The storage may be, for example, the memory 9a included in the ECU 9.

The storage stores, for example, the number of steps in the previous second travel mode when a change takes place from the first travel mode to the second travel mode. Thus, at a change between the travel modes, the regeneration level in the first travel mode that is currently selected can be compared with the previous regeneration level in the second travel mode, which is stored in the storage. Then, the regeneration level in the current first travel mode and the regeneration level in the previous second travel mode are compared, and the regeneration level having a larger deceleration force is set as the initial regeneration level.

According to such a control device 1 for a vehicle, for example, it is possible to set an operational feeling in the single-pedal mode after a mode change to an operational feeling similar to that at a time of the previous single-pedal mode, and to suppress a deceleration failure at a change between the travel modes.

A specific example of setting of the initial regeneration level will be described below with reference to FIG. 2. For example, in a case where Step 1, 2, or 3 is selected in the first travel mode, the initial regeneration level is Step 1 when a regeneration level or step in the previous second travel mode, which is stored in the storage, is Step 1. The reason is as follows.

A step having the highest deceleration among Steps 1, 2, and 3 in the first travel mode is Step 3. Step 1 selected in the previous second travel mode has the same deceleration as Step 3 in the first travel mode. Thus, Step 1 is set as the initial regeneration level.

Similarly, in a case where Step 1, 2, or 3 is selected in the first travel mode, the initial regeneration level is set to Step 2 when the previous second travel mode is at Step 2, the initial regeneration level is set to Step 3 when the previous second travel mode is at Step 3, and the initial regeneration level is set to Step 4 when the previous second travel mode is at Step 4.

Then, in a case where Step 4 is selected in the first travel mode, the initial regeneration level is set to Step 2 when the previous second travel mode stored in the storage is at Step 2.

Step 4 in the first travel mode and Step 2 in the second travel mode have the same deceleration. Thus, Step 2 is set as the initial regeneration level.

Similarly, in a case where Step 4 is selected in the first travel mode, the initial regeneration level is set to Step 3 when the previous second travel mode is at Step 3, and the initial regeneration level is set to Step 4 when the previous second travel mode is at Step 4.

Then, in a case where Step 5 is selected in the first travel mode, the initial regeneration level is set to Step 3 when the previous second travel mode stored in the storage is at Step 1, 2, or 3.

Step 5 in the first travel mode and Step 3 in the second travel mode have the same deceleration. Thus, even when the previous second travel mode is at Step 1 or 2, the initial regeneration level is set to Step 3 in the second travel mode, which has a deceleration equivalent to that in Step 5 in the first travel mode.

Similarly, in a case where Step 5 is selected in the first travel mode, the initial regeneration level is set to Step 4 when the previous second travel mode is at Step 4.

Then, in a case where Step 6 is selected in the first travel mode, the initial regeneration level is set to Step 4 when the previous second travel mode stored in the storage is at any of Steps 1, 2, 3, and 4.

Step 6 in the first travel mode and Step 4 in the second travel mode have the same deceleration. Thus, even when the previous second travel mode is at Step 1, 2, or 3, the initial regeneration level is set to Step 4 in the second travel mode, which has a deceleration equivalent to that in Step 6 in the first travel mode.

### Change from D Range

A change from the first travel mode to the second travel mode is described above. The following describes setting of the initial regeneration level when a transition is made from the D range to the second travel mode. The initial regeneration level may be set to the number of steps in the previous second travel mode, which is stored in the storage, when a transition is made from the D range to the second travel mode.

In this case, as illustrated in FIG. 2, the initial regeneration level is set to Step 1 in a case where the previous step is Step 1. Similarly, the initial regeneration level is set to Step 2 in a case where the previous step is Step 2, the initial regeneration level is set to Step 3 in a case where the previous step is Step 3, and the initial regeneration level is set to Step 4 in a case where the previous step is Step 4.

### Travel Modes and Number of Steps

As described above, the first travel mode as the two-pedal mode has six deceleration steps. On the other hand, the second travel mode as the single-pedal mode has four deceleration steps.

A predetermined selection range of regeneration levels included in the first travel mode is defined as a first regeneration level. Similarly, a predetermined selection range of regeneration levels included in the second travel mode is defined as a second regeneration level. The first regeneration level and the second regeneration level can be said to be a range of regeneration levels that is changeable, that is, a range of strength of deceleration that is changeable.

As exemplified by Step 6 in the first travel mode and Step 4 in the second travel mode, the second regeneration level may be set to be narrower than the first regeneration level. In addition, the second regeneration level may have a smaller number of selectable steps than the first regeneration level.

According to such a control device 1 for a vehicle, when a change takes place to a travel mode having a different number of steps included, the previous regeneration level is considered irrespective of a difference in the number of steps before and after the change, and thus the initial deceleration force can be set to deceleration force that is suitable for a travel scene.

For example, even in a case where the number of steps included is different between the travel modes as in the example illustrated in FIG. 2, in which Step 1 in the second travel mode corresponds to Step 3 in the first travel mode and Step 2 in the second travel mode corresponds to Step 4 in the first travel mode, deceleration steps having the same deceleration are identified among the deceleration steps in the travel modes. Accordingly, even in a case where the range of regeneration levels or the like is different between the travel modes, the deceleration can be easily maintained or increased at a change between the travel modes.

By providing a travel mode having a range with a small number of regeneration levels, regenerative braking force can be easily controlled to increase and decrease with fewer operations, and an operational burden on the driver can be reduced.

In a travel mode having a range with a large number of regeneration levels, the regeneration level can be finely set.

### Travel Modes and Number of Pedals

The first travel mode is a two-operation-member travel mode in which acceleration and deceleration of the vehicle are performed by two operation members, in other words, the accelerator operation member 14a and the brake operation member 14b. The second travel mode is a one-operation-member travel mode in which acceleration and deceleration of the vehicle are performed by one operation member (acceleration-deceleration operation member (accelerator operation member 14a)).

According to such a control device 1 for a vehicle, the two-operation-member travel mode and the one-operation-member travel mode can be switched. In an operation by a single pedal in the second travel mode in which the frequency of pedal switching is low, an effect of reducing an operational burden of the pedal is obtained. In addition, the range of regeneration levels that can be selected is smaller in the second travel mode. Thus, an operational burden on the driver can be further reduced.

The second travel mode (single-pedal travel mode) is assumed to be used in a situation in which starting and stopping are frequently repeated during traveling in a town, as the IDS is set to CITY. Thus, driving is enabled only by an operation of the accelerator operation member 14a as the single acceleration-deceleration operation member. Accordingly, the driver is freed from operating the brake operation member 14b, and an operational burden is reduced.

In addition, in the second travel mode, for example, from Step 1 to Step 4, the range of regeneration levels that can be selected is narrower and the number of deceleration steps is smaller than in the first travel mode. Accordingly, a burden of setting the deceleration steps by the driver is reduced, and an operational burden on the driver can be further reduced.

### Operation for Changing Regeneration Level

The regeneration level may be configured to be changeable by, for example, an operation member provided on the steering wheel.

For example, the plus paddle 10a and the minus paddle 10b included in the operation unit 10 may be used as operation members for changing the regeneration level. FIG. 2 illustrates an example of a change of the regeneration level, specifically, a change of the deceleration step in the second travel mode. As illustrated in FIG. 2, the deceleration step sequentially decreases from Step 1 to Step 4 by an operation of the minus paddle. The deceleration step increases from Step 4 to Step 1 by an operation of the plus paddle.

According to such a control device for a vehicle, for example, at a travel mode change from the two-pedal travel mode (first travel mode) to the single-pedal travel mode (second travel mode), the same operational feeling can be set for an operation member for setting deceleration force by regeneration force although an operational feeling by a pedal operation member under a foot changes. Accordingly, a sense of discomfort felt by the driver can be reduced.

Moreover, since the deceleration level can be changed without releasing a hand from the steering wheel, an operational burden on the driver can be reduced.

A change of the regeneration level may be configured to be changeable by the same operation member in the first travel mode and the second travel mode.

According to such a control device for a vehicle, in addition to enabling a change of the deceleration level without releasing a hand from the steering wheel, the regeneration level can be changed by operating the same operation member in each travel mode. Thus, the driver can obtain desired deceleration force without feeling a sense of discomfort even when a change takes place between the travel modes. Accordingly, the driver can easily continue driving without being conscious of a change between the travel modes.

Note that the present invention is not limited to the above-described embodiment, and changes and modifications within a scope in which the object of the present invention can be achieved are included in the present invention.

### EXPLANATION OF REFERENCE NUMERALS

1 control device

2 engine (power source, drive source)

3 clutch

4 automatic transmission

5 hydraulic circuit

6 differential mechanism

7 drive shaft

8 drive wheel

9 ECU (deceleration unit)

9a memory

10 operation unit (shift device, paddle shift)

10a plus paddle (first operation unit)

10b minus paddle (second operation unit)

10c single pedal switch

11 steering unit

12 traveling state detection unit

13 operation-member operation detection unit

14a accelerator operation member

14b brake operation member

15 motor (electric motor, electric generator, deceleration unit)

16 battery

What is claimed is:

1. A control device for a vehicle that includes an electric motor as a drive source for traveling,
the control device capable of changing deceleration force of the vehicle in accordance with a magnitude of regeneration level of the electric motor,
the control device having a plurality of travel modes in which the regeneration level is changeable by an operation of a driver, wherein
the plurality of travel modes includes a first travel mode and a second travel mode, and
when a change takes place from the first travel mode to the second travel mode, the control device sets an initial regeneration level of the second travel mode based on the regeneration level selected in the first travel mode.

2. The control device according to claim 1, wherein when a change takes place from the first travel mode to the second travel mode,
the control device sets an initial regeneration level at a time of the change to the second travel mode to a regeneration level that is substantially the same in the deceleration force as the regeneration level selected in the first travel mode, or a regeneration level that is greater in the deceleration force than the regeneration level selected in the first travel mode.

3. The control device according to claim 1, comprising a storage configured to store the regeneration level selected before a change between the travel modes, wherein
when a change takes place between the travel modes, the control device compares the regeneration level in the first travel mode that is currently selected with a previous regeneration level in the second travel mode that is stored in the storage, and sets the initial regeneration level to the regeneration level or the previous regeneration level which is greater in the deceleration force.

4. The control device according to claim 1, wherein
a range of the regeneration level that is changeable includes
a first regeneration level having a predetermined selection range in the first travel mode, and
a second regeneration level having a smaller selection range than the first regeneration level in the second travel mode.

5. The control device according to claim 1, wherein
the first travel mode is a two-operation-member travel mode in which acceleration and deceleration of the vehicle are performed by two operation members, and
the second travel mode is a one-operation-member travel mode in which acceleration and deceleration of the vehicle are performed by one operation member.

6. The control device according to claim 1, wherein the regeneration level is changeable by an operation member provided on a steering wheel.

7. The control device according to claim 1, wherein the regeneration level is changeable by the same operation member in the first travel mode and the second travel mode.
